(19) United States
(12) Patent Application Publication
(10) Pub. No.: US 2013/0053056 A1
(43) Pub. Date: Feb. 28, 2013

(54) FACILITATING MOBILE DEVICE POSITIONING

(71) Applicants: Alok Aggarwal, Foster City, CA (US); Payam Pakzad, Mountain View, CA (US)

(72) Inventors: Alok Aggarwal, Foster City, CA (US); Payam Pakzad, Mountain View, CA (US)

(73) Assignee: QUALCOMM Incorporated, San Diego, CA (US)

(21) Appl. No.: 13/220,388

(22) Filed: Aug. 29, 2011

(51) Int. Cl. H04W 24/00

(52) U.S. Cl. 455/456.1

(57) ABSTRACT

The subject matter disclosed herein may relate to methods, apparatuses, systems, devices, articles, or means for facilitating mobile device positioning. For certain example implementations, a method for a mobile device may comprise identifying an uncertainty of at least one estimate of a location of the mobile device. Signals to acquire that are transmitted from multiple transmitters for use in at least reducing the uncertainty of the at least one estimate of the location of the mobile device may be prioritized based, at least in part, on one or more characteristics associated with the multiple transmitters and at least one constraint on the at least one estimate of the location of the mobile device in accordance with a navigational path of the mobile device. Other example implementations are described herein.

### BACKGROUND

1. Field

The subject matter disclosed herein relates to facilitating mobile device positioning and more specifically, but by way of example only, to prioritizing signals to acquire for use in facilitating mobile device positioning.

2. Information

Paper maps have been used by people for hundreds, if not thousands of years, to aid navigation in unfamiliar or foreign territories. Electronic maps began to be available during the twentieth century. With the advent of the Internet, people could electronically access maps of many places from all over the globe. Web-based mapping services could also provide directions from point “A” to point “B”. These directions from web-based mapping services were relatively static. With the invention of satellite-positioning system (SPS) technology and ever-smaller electronic devices, however, so-called turn-by-turn directions could be provided dynamically as travelers journeyed toward their destination.

Electronic maps, web-based mapping services, and turn-by-turn directions focus on providing navigational aids in certain situations and in particular environments. Unfortunately, there are other situations or different environments for which they are not intended or have not been designed. Consequently, there remain a number of situations, environments, etc. in which navigational or other location-based services may be improved.

### BRIEF DESCRIPTION OF THE FIGURES

Non-limiting and non-exhaustive aspects, features, etc. will be described with reference to the following figures, wherein like reference numerals may refer to like parts throughout the various figures.

FIG. 1 is a schematic diagram of a path traveled by a mobile device shown with example uncertainties at estimated locations according to an implementation.

FIG. 2 depicts an example scenario in which an uncertainty of an estimated location of a mobile device may be reduced according to an implementation.

FIG. 3 is a schematic diagram of an example constrained environment in which a mobile device may travel over a path according to an implementation.

FIG. 4 is a flow diagram illustrating an example method for a mobile device to facilitate positioning according to an implementation.

FIG. 5 is a flow diagram illustrating an example method for a mobile device to facilitate positioning based at least partially on at least one computed measurement utility according to an implementation.

FIG. 6 is a schematic diagram illustrating example uncertainties in an estimated location of a mobile device as represented by multiple particles that may be propagated along at least one hallway of a building according to an implementation.

FIG. 7 is a schematic diagram of an indoor environment having multiple transmitter devices that may be prioritized for example signal reception measurements by a mobile device according to an implementation.

FIG. 8 is a schematic diagram illustrating an example mobile device, according to an implementation, that may implement one or more aspects relating to facilitating mobile device positioning.

### SUMMARY

For certain example implementations, a method for a mobile device may comprise: identifying an uncertainty of at least one estimate of a location of the mobile device; and prioritizing signals to acquire that are transmitted from multiple transmitters for use in at least reducing the uncertainty of the at least one estimate of the location of the mobile device based, at least in part, on one or more characteristics associated with the multiple transmitters and at least one constraint on the at least one estimate of the location of the mobile device in accordance with a navigational path of the mobile device. For certain example implementations, a mobile device may comprise: a receiver; and a processor to: identify an uncertainty of at least one estimate of a location of the mobile device; and prioritize acquisition of signals received at the receiver and transmitted from multiple transmitters for use in at least reducing the uncertainty of the at least one estimate of the location of the mobile device based, at least in part, on one or more characteristics associated with the multiple transmitters and at least one constraint on the at least one estimate of the location of the mobile device in accordance with a navigational path of the mobile device. For certain example implementations, an apparatus may comprise: means for identifying an uncertainty of at least one estimate of a location of the mobile device; and means for prioritizing signals to acquire that are transmitted from multiple transmitters for use in at least reducing the uncertainty of the at least one estimate of the location of the mobile device based, at least in part, on one or more characteristics associated with the multiple transmitters and at least one constraint on the at least one estimate of the location of the mobile device in accordance with a navigational path of the mobile device. For certain example implementations, an article may comprise: a storage medium comprising machine-readable instructions stored thereon which are executable by a special purpose computing apparatus to: identify an uncertainty of at least one estimate of a location of a mobile device; and prioritize acquisition of signals received at a receiver and transmitted from multiple transmitters for use in at least reducing the uncertainty of the at least one estimate of the location of the mobile device based, at least in part, on one or more characteristics associated with the multiple transmitters and at least one constraint on the at least one estimate of the location of the mobile device in accordance with a navigational path of the mobile device. It should be appreciated, however, that these are merely example implementations and that other implementations are described herein and may be implemented without departing from claimed subject matter.

### DETAILED DESCRIPTION

Reference throughout this Specification to “a feature,” “one feature,” “an example,” “one example,” and so forth means that a particular feature, structure, characteristic, or aspect, etc. that is described in connection with a feature or example may be relevant to at least one feature or example of claimed subject matter. Thus, appearances of a phrase such as “in one example,” “for example,” “in one feature,” “a feature,” “a particular feature,” “in an example implementation,” or “for certain example implementations,” etc. in various places throughout this Specification are not necessarily all referring to the same feature, example, or example implementation. Furthermore, particular features, examples, structures, characteristics, or aspects, etc. may be combined in one or more example devices, example methods, example apparatuses, or other example implementations.

A navigational service may include, by way of example but not limitation, determining a position or positioning, providing a map, indicating a current location on a map, providing static directions, providing real-time turn-by-turn directions, or any combination thereof, etc. Many indoor areas are sufficiently large, complex, or otherwise difficult to navigate so that navigational services may be desirable to an individual currently located in an indoor area. Because a mobile device may be carried by an individual, a user of a mobile device may want a navigational service or another location-based service (LBS) to be provided at an indoor area via a mobile device. Location-based services may include a navigational service such as personal vehicle/pedestrian navigation, location-based offers for goods or services, location-based searching (e.g., searching of local points of interest), or any combination thereof, etc., just to name a few examples.

Positioning strategies that are effective in outdoor environments, which may utilize satellite positioning system (SPS) signals or satellite imagery, may be inadequate for indoor environments. Thus, as is explained further herein below, performing a positioning operation indoors to estimate a location of a mobile device may involve different techniques or strategies as compared to those that may be used outdoors. To account for differences indoors, mobile devices may attempt to effectuate indoor positioning at least partly by processing signals transmitted from transmitters (e.g., wireless transmitter devices) that are located, for example, within an indoor environment at known locations. Examples of transmitters may include, but are not limited to, wireless transmitter devices that comport with a Wi-Fi access point protocol (e.g., IEEE 802.11), a Bluetooth protocol, a femtocell protocol, or any combination thereof, etc.

As a user travels within an indoor area while carrying a mobile device, position estimates of the mobile device may be at least partially determined using, for example, one or more signals transmitted from at least one transmitter. A mobile device may measure characteristics of signals received from one or more transmitters. Such measured characteristics may include, but are not limited to, received signal strength indicator or indication (RSSI) measurements, round trip time (RTT) measurements, round trip delay (RTD) measurements, time of arrival (TOA) measurements, angle of arrival (AOA) measurements, or combinations thereof, etc.

Using measurements of received wireless signals (e.g., wireless signal reception measurements), along with techniques that are known in the art (e.g., trilateration), a location of a mobile device may be estimated. With trilateration, for example, a mobile device may use well known techniques to obtain a position fix from ranges to transmitters that are positioned at known locations. Ranges may be measured based, at least in part, on received wireless signal characteristics (e.g., RSSI, RTT, RTD, etc.). Furthermore, a speed or a direction may be estimated using wireless signal reception measurements, one or more position estimates, or any combination thereof, etc. For instance, an estimated velocity, which may include both a speed and a direction, may be estimated from a trajectory derived from at least two estimated positions that are associated with respective timestamps, such as times at which wireless signal reception measurements are taken.

Wireless signal reception measurements with one or more transmitters may enable estimation of a location of a mobile device or may aid in “fine-tuning” an estimated location. Measuring at least one characteristic (e.g., RSSI, RTT, RTD, TOA, AOA, etc.) of one or more signals received from one or more transmitters may comprise an example of a direct measurement that a mobile device may perform as at least part of a procedure to determine an estimated location. Unfortunately, direct measurements may be costly in terms of energy usage, latency, or computational complexity. In contrast, indirect mechanisms for determining an estimated location may involve a relatively lower cost in terms of energy usage, latency, or computational overhead. Here, an indirect mechanism may obtain or incorporate indirect measurements which have a relative bearing or indirect indication of an absolute indication of location or range to a reference point.

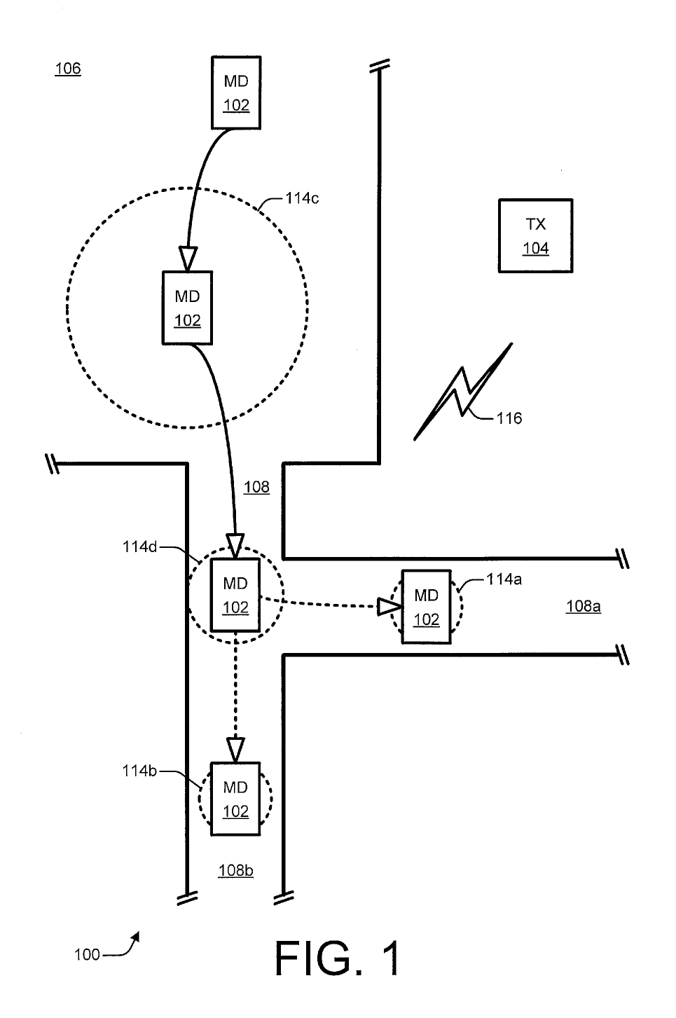

Indirect mechanisms may indicate, for example, relative positional movement of a mobile device. Indirect measurements may be obtained come from, by way of example only, one or more inertial sensors such as accelerometer(s), pedometer(s), compass(es), gyroscope(s), or any combination thereof, etc. Additionally or alternatively, indirect mechanisms may comprise using, by way of example only, at least one mobility model that considers minimum or maximum velocity of a pedestrian, a previous location, a previous velocity (e.g., a previous speed or a previous direction of travel, etc), a path smoothing procedure, or any combination thereof, etc. Example approaches to implementing indirect mechanisms, as well as additional examples thereof, are described further herein below with particular reference to at least FIG. 1, 2, or 3.

Indirect mechanisms may be favored in certain circumstances as compared to direct measurements because of their lower resource costs. However, locations of mobile devices that are estimated using indirect mechanisms may include or be associated with an uncertainty. Direct measurements may be used to resolve at least a portion of an uncertainty of an estimated location that is e.g. derived from indirect mechanisms, but with a resource cost in terms of power usage, latency, computational complexity, or a combination thereof, etc. An informed or considered selection of which direct measurement or measurements to perform from multiple available direct measurements may enable at least a portion of an uncertainty of an estimated location to be resolved while using fewer resources than if an uninformed or random selection of direct measurement(s) were performed.

For certain example implementations, at least one estimate of a location of a mobile device may be obtained using one or more indirect mechanisms within an indoor environment. An uncertainty of at least one estimate of a location of a mobile device may be identified. One or more characteristics that are associated with multiple transmitters that are accessible from an indoor area may be obtained. Signal reception measurements with multiple transmitters may be prioritized for use in at least reducing an uncertainty of at least one estimated location of a mobile device. Uncertainty of at least one estimated location of a mobile device may be reduced based, at least in part, on one or more characteristics associated with multiple transmitters in conjunction with the at least one estimated location of the mobile device.

In certain example implementations, one or more characteristics of multiple transmitters may include, but are not limited to, a location of a transmitter, a communication protocol implemented by a transmitter, an expected signal reception measurement value with a transmitter in a vicinity of an estimated location of a mobile device, transmission power, signal transmission bandwidth, indication of signal quality such as signal-to-noise ratio or any combination thereof, etc. If a signal reception measurement from a particular transmitter is, for example, unlikely to reduce an uncertainty of an estimated location, then a mobile device may rank acquisition of signals from the particular transmitter lower as compared to a priority ranking given to acquiring signals from one or more other transmitters that is or are more likely to reduce the uncertainty of the estimated location.

Thus, for certain example implementations, a user may carry a mobile device as the user travels around an indoor environment. To track a user, estimated locations of a mobile device may be determined. For example, a navigational path of a mobile device may be determined (e.g., extended segment by segment) using one or more indirect mechanisms (e.g., using at least one inertial sensor, at least one mobility model, any combination thereof, etc.) to determine a current estimated location of the mobile device. Applying an indirect mechanism may use fewer resources than making one or more direct measurements, but a location estimated using an indirect mechanism may have an associated uncertainty that is greater than an acceptable tolerance threshold. Such an uncertainty may be at least reduced using measurements made of characteristic(s) of signals received from one or more transmitters. Each direct measurement may consume resources, so a total consumption of resources may be reduced if signals to be acquired from one or more transmitters are prioritized or fewer than all available signals are acquired. By way of example but not limitation, acquisition of a first signal from a first transmitter that is expected to reduce an uncertainty of an estimated location by a first amount may be prioritized higher than acquisition of a second signal from a second transmitter that is expected to reduce an uncertainty of an estimated location by a lower, second amount.

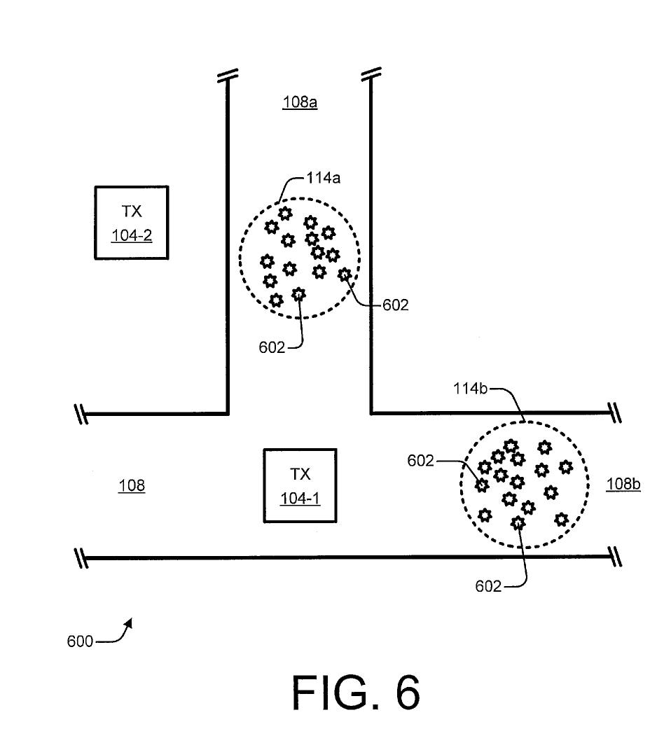

In an example implementation, particle filtering may be used to determine an estimated location of a mobile device. With particle filtering, potential locations of a mobile device may be represented by particles in a particle cloud that are propagated using a probabilistic model. If a user is approaching an intersection where one of two possible hallways may be taken, for instance, particles of a particle cloud may split into two particle cluster positions with a first particle cluster propagating down a first hallway and a second particle cluster propagating down a second hallway. If two potential particle cluster positions of an estimated location of a mobile device are approximately equidistant from a particular transmitter, then acquiring signals transmitted from the particular transmitter may not significantly reduce an uncertainty associated with the two potential particle cluster positions. Example particle cloud scenarios are described further herein below with particular reference to at least FIG. 6. It should be understood that claimed subject matter is not limited to any of these particular example implementations. Moreover, additional example implementations for facilitating mobile device positioning are described further herein below.

FIG. 1 is a schematic diagram 100 of a path traveled by a mobile device shown with example uncertainties at estimated locations according to an implementation. Schematic diagram 100 may depict part of a map that represents at least a portion of an indoor environment, such as a floor of a building. As illustrated, schematic diagram 100 may include at least one mobile device 102; at least one transmitter 104; at least one open space 106; one or more hallways 108, 108a, or 108b; one or more uncertainties 110, 112, 114a, or 114b that are associated with estimated locations of mobile device 102; or at least one signal 116. For the sake of visual clarity, but not by way of limitation, at least some uncertainties 110, 112, 114a, or 114b may be shown in FIG. 1 with dashed lines.

For certain example implementations, a user (not explicitly shown in FIG. 1) may travel in an indoor environment while carrying a mobile device 102. Mobile device 102 is illustrated at various positions at open space 106 or hallway 108, 108a, 108b along a path (that is depicted by arrows with hollow arrowheads) that may be traversed by a user. A mobile device 102 may communicate via one or more wireless signals 116 with transmitter 104 from time to time. A signal 116 may be, for example, transmitted from a mobile device 102 and received at a transmitter 104 or transmitted from a transmitter 104 and received at a mobile device 102. Although only one mobile device 102 or one transmitter 104 is explicitly shown in schematic diagram 100, more or less than one of either or both may alternatively be involved in a given implementation without departing from claimed subject matter.

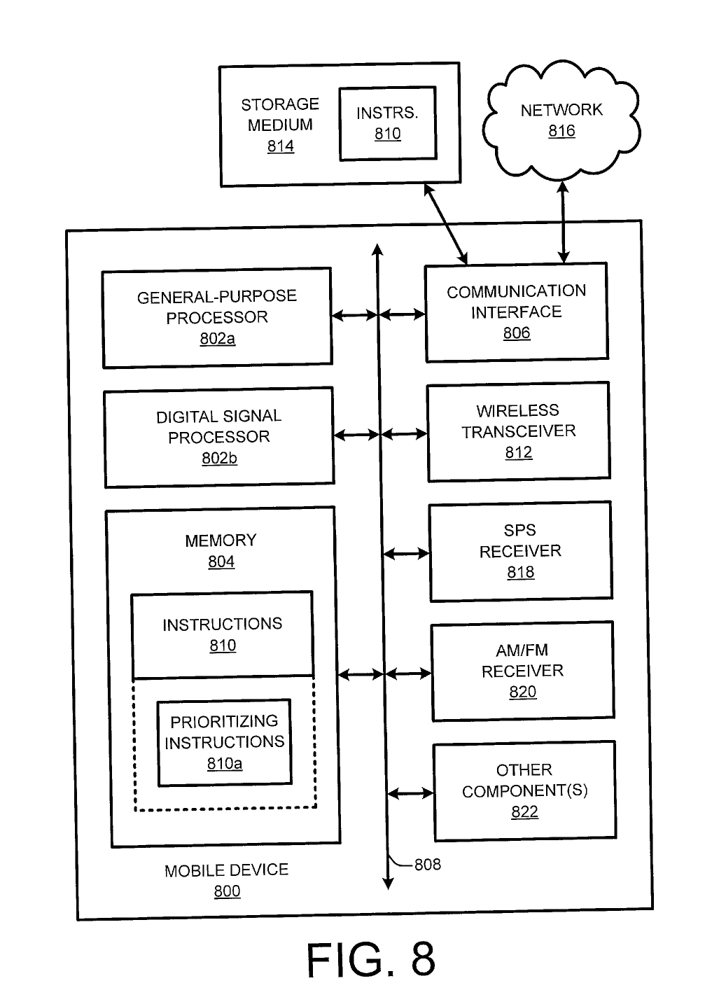

Examples of mobile device 102 may include, but are not limited to, a mobile phone, a mobile station, a user equipment, a smart phone, a cellular phone, a netbook, a laptop computer, a notebook computer, a tablet computer, a slate computer, a personal digital assistant (PDA), a personal navigation device (PND), an entertainment appliance, an e-book reader, or some combination thereof, etc., just to name a few examples. Furthermore, a mobile device 102 may comprise any mobile device with wireless communication capabilities. Example realizations for a mobile device, as well as additional mobile device examples, are described herein below with particular reference to at least FIG. 8. However, claimed subject matter is not limited to any particular type, size, category, capability, etc. of a mobile device.

In example implementations, a transmitter 104 may comprise a Wi-Fi or wireless local area network (WLAN) access point (AP), a femtocell nodal device, a WiMAX nodal device, an indoor location beacon, sonar or acoustical beacons, a Bluetooth or other similarly short-ranged wireless node, or any combination thereof, etc., just to name a few examples. A transmitter 104 may transmit signals 116 including, but not limited to, those that are capable of identifying a particular wireless access device or those that may be useful for estimating a position of a mobile device. A mobile device 102 may be within wireless communication range of one or more transmitters 104 or in wireless communication with one or more transmitters 104. A transmitter 104 may also be capable of receiving wireless signals or may comprise a wireless access device generally that is capable of both transmitting and receiving wireless signals. A transmitter 104 may be located such that it corresponds to or is capable of communicating with mobile devices that are within a particular indoor area.

An indoor area, for example, may be referred to as a “location context.” A mobile device or a server device may store or associate location context identifiers (LCIs) with specific “location contexts.” A location context may comprise, by way of example but not limitation, a locally-defined environment or other area that may not be mapped according to a global coordinate system. A given indoor area or other location context may be associated with at least a portion of at least one local coordinate system, at least a portion of at least one global coordinate system, at least a portion of at least one local coordinate system that may be translated into one or more other local coordinate systems or global coordinate systems, or any combination thereof, etc., just to name a few examples. A particular location context may comprise, by way of example but not limitation, a particular indoor area, a particular floor of a building, a particular section or portion of a building, or any combination thereof, etc. However, claimed subject matter is not limited to any particular coordinate system or systems or to any particular location context.

During wireless communication(s), signals 116 that are received at a mobile device 102 from a particular transmitter 104 may be modulated with a unique device identifier identifying the particular transmitter 104. For a Wi-Fi AP implementation of a transmitter 104, by way of example but not limitation, a unique device identifier may comprise an AP medium access control identifier (MAC ID). A transmitter 104 may further interact with a mobile device 102 so as to enable signal reception measurements to be performed by a mobile device 102. Signal reception measurements may include, but are not limited to, RSSI measurements, RTT measurements, RTD measurements, TOA measurements, AOA measurements, or any combination thereof, etc.

As a mobile device travels within an indoor area, position estimates of the mobile device may be determined using, for example, signals received from one or more transmitters that are positioned at known locations. For example, a range between a mobile device and a transmitter may be estimated using one or more signal characteristics, such as RSSI, RTT, RTD, TOA, AOA, or any combinations thereof, etc. Determining an estimated range to a transmitter having a known location may enable a mobile device to determine its location within an indoor area along a circle, or portion thereof (e.g., an arc), having a center where the transmitter is located. By acquiring a unique device identifier that is modulated in a signal from a transmitter having a known location, a mobile device may at least determine an estimated location based on an estimated range to the transmitter. An estimated range to a transmitter having a known location may be used to refine an estimated location or at least reduce an uncertainty of an estimated location. Additionally or alternatively, a mobile device may determine one or more estimated ranges to one or more transmitters to determine an estimated location. Using measurements from at least three transmitters along with techniques that are known in the art (e.g., trilateration), a position of a mobile device may be estimated by combining three or more ranges. In other words, with trilateration for example, a mobile device may use well known techniques to obtain a position fix using ranges to transmitters at know locations with ranges determined at least partly from received wireless signal characteristics (e.g., RSSI, RTT, RTD, TOA, AOA, etc.).

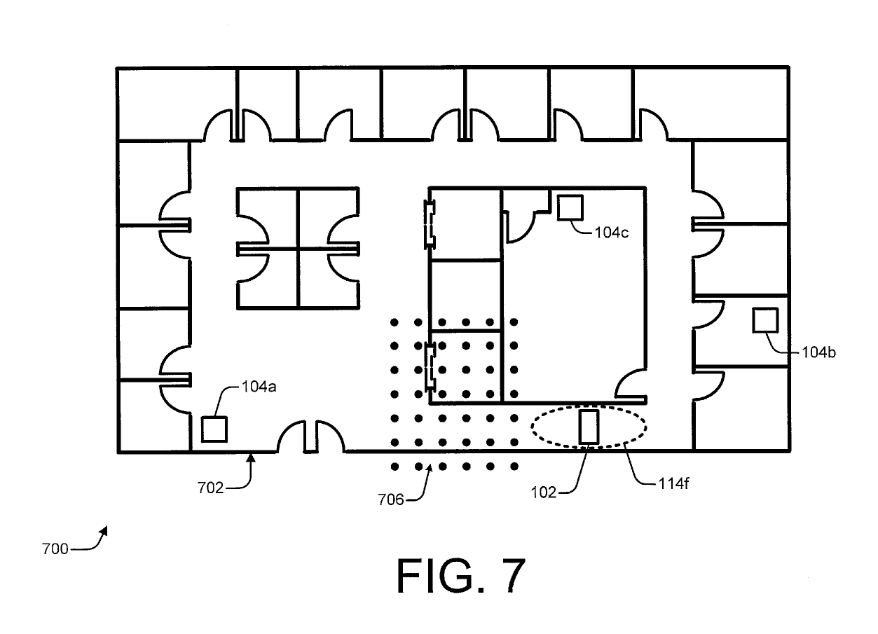

Additionally or alternatively, a mobile device may obtain a position fix based, at least in part, on a comparison of received wireless signal characteristics (e.g., RSSI, RTT, RTD, TOA, AOA, etc.) to one or more values of a heatmap. A heatmap may indicate one or more received wireless signal characteristic values that correspond to a given position within an indoor environment. If a mobile device acquires at least one signal having characteristic(s) that match wireless signal characteristic value(s) that correspond to a given position as indicated by a heatmap, then the mobile device may infer that it is possible that the mobile device is located at the given position. Example implementations for heatmaps are described further herein below with particular reference to FIG. 7.

As a mobile device is carried by a traveling user, for example, at least one antenna of the mobile device may be affected by electromagnetic signals. A radio frequency signal may, for instance, excite electrons of an antenna of a mobile device. However, little to no power may be used by a mobile device that has an antenna that is being affected by a propagating electromagnetic signal in such a manner. On other hand, if a mobile device is to acquire an electromagnetic signal, some amount of energy may be drawn from a power source, such as a battery. A mobile device may acquire a signal by, for example, demodulating the signal, providing power to a receiver of the mobile device, providing power to a processor (e.g., a baseband process) of the mobile device to process the signal, obtaining a characteristic (e.g., RSSI, RTT, RTD, TOA, AOA, etc.) of the signal, obtaining a unique identifier of a transmitter that transmitted the signal, or any combination thereof, etc., just to name a few examples.

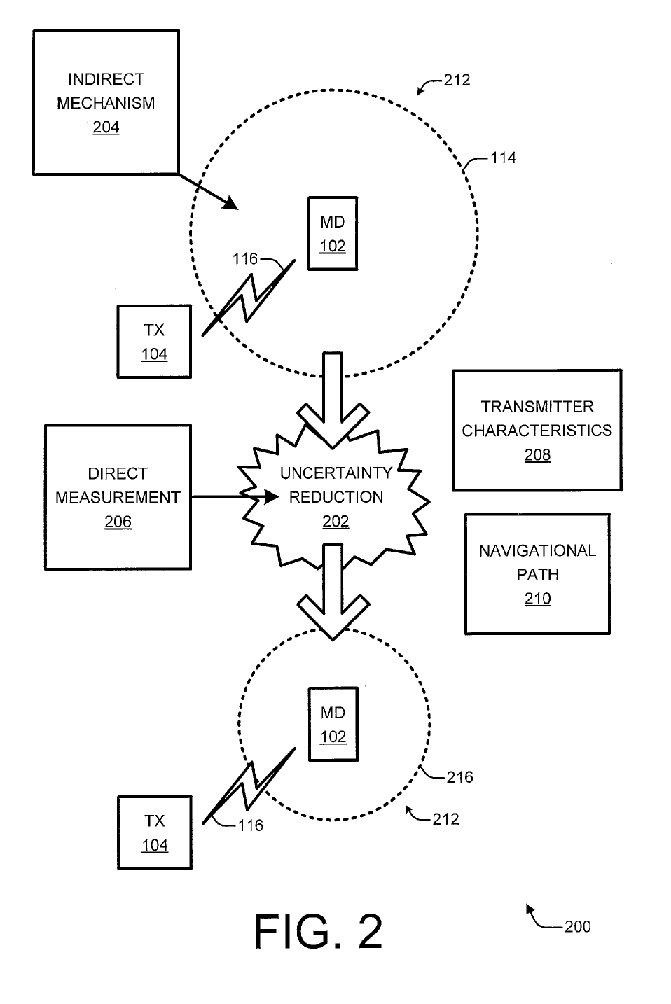

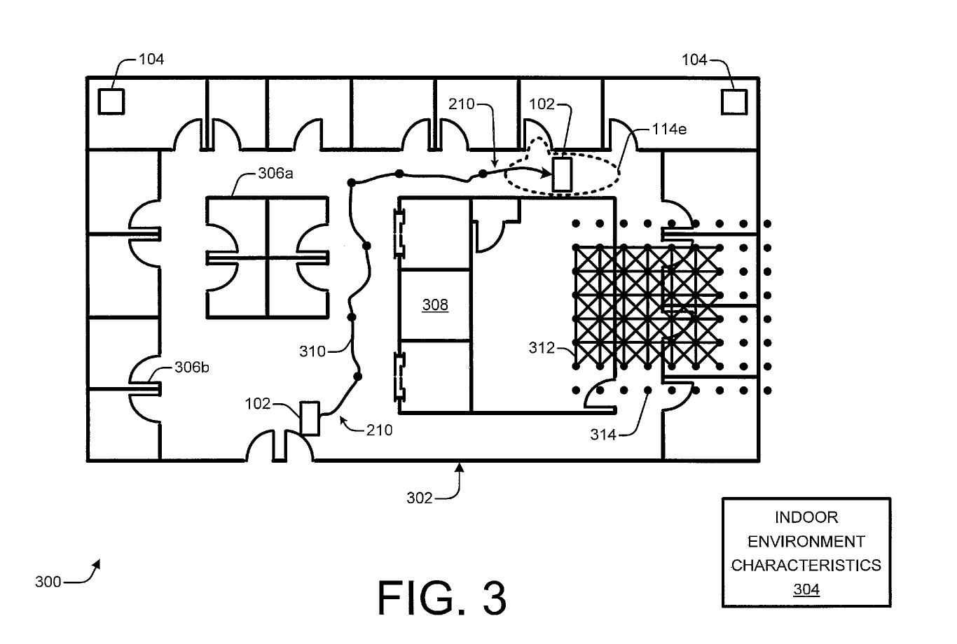

A trajectory or navigational path of mobile device 102 while traveling in an indoor environment is depicted by solid arrows or dashed arrows in schematic diagram 100. In accordance with certain example indoor positioning paradigms, mobile devices may estimate their locations using, for example, one or more indirect mechanisms, such as sensor measurements, mobility models, or combinations thereof, etc. Indirect mechanisms are described further herein below, with particular reference to at least FIG. 2 or 3. At least if one or more indirect mechanisms are used to determine an estimated location of a mobile device 102, an uncertainty may be associated with a location estimate. Example uncertainties 110, 112, 114a, or 114b are shown in FIG. 1.

In an example implementation, an uncertainty 110 may result from a location estimate within open space 106 that is determined using one or more sensor measurements, such as at least one accelerometer measurement, at least one gyroscope measurement, at least one pedometer measurement, or a combination thereof, etc. As shown, an estimated location may comprise a likely position of a mobile device 102 or an uncertainty 110 that corresponds to an error range around a likely position within open space 106. Because sensor measurements may be relative or because errors from indirect mechanisms may compound over time, an uncertainty may increase as a mobile device is moved if a direct measurement is not performed to refine an estimated location from one or more indirect mechanisms.

In an example implementation, an uncertainty 112 may result from a location estimate that is determined using one or more mobility models, such as at least one probabilistic propagation model. As shown, a path for mobile device 102 may be determined, in a likely or probabilistic sense, to enter a hallway 108 from open space 106. By taking into consideration a limiting width of hallway 108 as may be indicated in a schematic map of a corresponding indoor environment, uncertainty 112 may be smaller than uncertainty 110.

In example implementations, estimated locations for a mobile device 102 may be propagated probabilistically. Determination of location estimates of a mobile device or a trajectory or a path of a mobile device within an indoor area may be enabled or enhanced using one or more probabilistic mechanisms. By way of example but not limitation, a position of a mobile device may be represented as a probability distribution. A probability distribution may comprise, by way of example but not limitation, a range of possible values that a random variable may take, a probability that a value of a random variable falls within a e.g. measurable subset of a range of possible values, or any combination thereof, etc. To model a mobile device's movement around a physical indoor area, a probability distribution may be propagated around a schematic map modeling or representing a physical indoor area. To implement a probabilistic mechanism, a Bayesian or smoothing filter may be applied to location estimates or a process of determining location estimates. Implementation of a probabilistic mechanism may include consideration of a current trajectory of a mobile device. Additionally or alternatively, a Kalman filter or a particle filter may be applied to location estimates or a process of determining location estimates. Other probabilistic mechanisms may additionally or alternatively be implemented without departing from claimed subject matter.

With an example particle filtering implementation, by way of example only, a mobile device's locations or estimated locations may be represented by multiple particles. Each particle may represent a possible state or location of a mobile device. A combination of multiple particles (e.g., an average, a centroid, a mean, etc. with an error or confidence range) of a particle cloud may be considered at least one estimated location of a mobile device. Additionally or alternatively, one or more individual particles of multiple particles of a particle cloud may be considered at least one estimated location of a mobile device. In response to movement of a mobile device, particles may be propagated according to a probability distribution. Particles may be propagated in accordance with a probability distribution further along a corridor, around a corner, by branching at an intersection, by taking a portal (e.g., a stairway, an escalator, an elevator, etc.) to a different floor, or any combination thereof, etc.

In an example implementation, a propagated probability distribution may branch at an intersection. A branch at an intersection may indicate a prediction or estimate that a mobile device is taking one hallway with a likelihood that is greater than a likelihood of taking another hallway. A first uncertainty 114a or a second uncertainty 114b may correspond to an example intersection branching along hallway 108a or hallway 108b, respectively, by a mobile device 102. Using a mobility model, it may be unknown at a given time whether a user of mobile device 102 has taken hallway 108a or hallway 108b. However, performing one or more direct measurements with e.g. transmitter 104 may resolve or at least reduce first uncertainty 114a or second uncertainty 114b at a given time (e.g., or may resolve or at least reduce uncertainty 110 or 112 if performed at earlier times). As is described further herein, an amount of resource(s) that are consumed by performing one or more direct measurements may be lowered by prioritizing signal reception measurements so as to target a reduction of a level or an amount of uncertainty in at least one estimate of a location of a mobile device.

FIG. 2 depicts an example scenario 200 in which an uncertainty of an estimated location of a mobile device may be reduced according to an implementation. As illustrated, scenario 200 may include at least one mobile device 102, at least one transmitter 104, at least one uncertainty reduction operation 202, at least one indirect mechanism 204, at least one direct measurement 206, one or more transmitter characteristics 208, or at least one navigational path 210. Scenario 200 may further include at least one estimated location 212, at least one uncertainty 214 of estimated location 212, or at least one reduced uncertainty 216 of estimated location 212.

For certain example implementations, a mobile device 102 may determine estimated location 212 that is associated with uncertainty 214 using at least one indirect mechanism 204. Mobile device 102 may perform an uncertainty reduction operation 202 using at least one direct measurement 206. By way of example only, mobile device 102 may perform uncertainty reduction operation 202 based, at least in part, on one or more characteristics (e.g., RSSI, RTT, RTD, TOA, AOA, etc.) of at least one signal 116 that is received from a transmitter 104 or estimated location 212 of mobile device 102. With performance of uncertainty reduction operation 202, mobile device 102 may at least reduce an amount of uncertainty of estimated location 212. For instance, estimated location 212 of mobile device 102 may be associated with or characterized by a reduced uncertainty 216 by performing uncertainty reduction operation 202. Although an uncertainty reduction operation is illustrated in FIG. 2 with a reduced error range around a likely location, claimed subject matter is not so limited. For example, an uncertainty reduction may also or alternatively pertain to eliminating or reducing a likelihood that a user of a mobile device 102 has taken a particular fork from between or among multiple possible forks in a navigational path 210.

Transmitters 104 may be characterized by one or more transmitter characteristics 208. Example transmitter characteristics 208 may include, but are not limited to, a position of a transmitter, a transmission power of a transmitter, one or more protocols that a transmitter is capable of using to communicate wirelessly, at least one version of one or more protocols that a transmitter is capable of using to communicate wirelessly, interference levels that a receiver experiences if trying to receive signals transmitted by a transmitter, expected reception measurement values at various positions of an indoor area (e.g., via one or more heat maps), or any combination thereof, etc. Transmitter characteristics 208 may be stored separately from other navigational aids, or transmitter characteristics 208 may be stored with (e.g., including as part of) other navigational aids, such as by comprising at least a part of indoor environment characteristics. Examples of indoor environment characteristics are described herein further below with particular reference to at least FIG. 3. Claimed subject matter, however, is not limited to any particular types, formats, or organizations, etc. for transmitter characteristics. A navigational path 210 may comprise, by way of example but not limitation, a path that a mobile device may have traversed, may be traversing, may traverse, or any combination thereof, etc. Examples of navigational paths are described further herein below with particular reference to at least FIG. 3. Claimed subject matter, however is not limited to any particular indoor environment characteristics or navigational paths.

Indirect mechanisms 204 to determine an estimated location may comprise, by way of example but not limitation, indirect measurements, predictive procedures, mobility models, or any combinations thereof, etc. For example, a movement model may indicate a possible or likely movement pattern. Implementation of a movement model may include positional filtering, consideration of a likely speed of perambulation (e.g., a reasonable or maximum walking speed), or applying smoothness to a traveled path, etc., just to name a few examples. Additionally or alternatively, indoor environment characteristics may be analyzed as part of or in conjunction with an implementation of an indirect mechanism. For instance, a schematic map, feasible locations, or a routability graph (e.g., a graph indicating whether a given path is traversable by a person), etc., just to name a few examples, may be analyzed. As another example of indirect mechanisms, relative measurements may be used to estimate a location of a mobile device. Relative measurements may include measurements of positional displacement, heading, or speed, etc., just to name a few examples. Relative measurements may be made using, by way of example but not limitation, at least one accelerometer, at least one pedometer, at least one gyroscope, at least one compass, or any combination thereof, etc. Indirect mechanisms may be used alone or in any combination to estimate or to refine a location of a mobile device. Claimed subject matter, however, is not limited to any particular examples of indirect mechanisms.

Direct measurements 206 that may be used to determine or to refine an estimated location may comprise, by way of example but not limitation, measurements made with transmitters, measurements that are a direct function of a current position, absolute measurements, or any combination thereof, etc. Examples may include, but are not limited to, performing ranging procedures with one or more transmitters, consulting contours or positions of at least one heat map, matching features of a photographed image to features of images in a database, or any combination thereof, etc. Direct measurement may result in one or more signal characteristic values measured or otherwise obtained by acquiring at least one signal. Direct measurement examples may include a signal characteristic value (e.g., RSSI, RTT, RTD, TOA, AOA, etc.), barometric pressure, or any combination thereof, etc., just to name a few examples. Direct measurements may be used alone or in any combination to estimate or refine a location of a mobile device, including but not limited to at least reducing an uncertainty of an estimated location. It should be understood that claimed subject matter is not limited to any particular examples of direct measurements.

FIG. 3 is a schematic diagram 300 of an example constrained environment in which a mobile device may travel over a path according to an implementation. As illustrated, schematic diagram 300 may include an indoor area 302 or indoor environment characteristics 304. As shown, an indoor area 302 may include one or more transmitters 104, one or more obstacles 306, or at least one infeasible area 308, etc. Schematic diagram 300 may further include at least one mobile device 102, at least one navigational path 210, one or more segments 310 of a navigational path, at least one graph 312, at least one grid 314 of points, or at least one uncertainty 316.

For certain example implementations, indoor areas may comprise one or more indoor environments such as office buildings, shopping malls, airports, apartment buildings, arenas, convention centers, auditoriums, amphitheatres, warehouses, classroom buildings or schools, supermarkets, stadiums, a transit station terminal, a library, one or more floors thereof, interiors of other structures, or any combination thereof, just to name a few examples. In example implementations, indoor environment characteristics 304 may be descriptive of an indoor area 302 or may facilitate provision of a location-based service in conjunction with mobile devices that are located within a corresponding indoor area 302. By way of example but not limitation, indoor environment characteristics 304 may include at least a portion of one or more of any of the following: a schematic map of an indoor area, a connectivity graph e.g. for a schematic map, a routability graph e.g. for a schematic map, annotations e.g. for a schematic map, a heat map, transmitter characteristics 208 (e.g., of FIG. 2), identities of transmitters, points of interest for an indoor area, navigational instructions, at least one mobility model, or any combination thereof, etc. Additional description and examples of indoor environment characteristics 304, such as a schematic map, a graph, a heat map, etc., are described herein below with particular reference to FIG. 3 or 7.

In example implementations, an indoor area 302 may include one or more obstacles 306, such as a wall 306a or a door 306b. Obstacles 306 may include, but are not limited to, walls, doors, railings, columns, or barriers; furniture or cubicle dividers; or any combination thereof; etc. For the sake of visual clarity in FIG. 3, two obstacles 306a or 306b are specifically indicated by reference number; however, many obstacles are depicted. Obstacles 306 may exist in the physical world and may have corresponding representation(s) included as part of a schematic map of an indoor area 302. Although claimed subject matter is not so limited, obstacles 306 may thus include building features or other objects that may restrict movement around an indoor environment. Indoor environments may also have open spaces such as lobbies, common areas, entryways, or rooms, etc., just to name a few examples. Accordingly, because paths of movement in such an indoor environment may be restricted in some areas (although they may also be unrestricted in other, open spaces), an indoor environment may comprise an example of a constrained environment.

In example implementations as depicted in FIG. 3, an indoor area 302 may be represented as a schematic map. A schematic map may comprise, by way of example only, one or more features that are descriptive of at least one indoor area 302. Features of a map may represent, by way of example but not limitation, attributes of a physical layout or a physical organization of at least one indoor area 302. For example, features of a map may indicate locations, lengths, or sizes, etc. of walls 306a, rooms, doors 306b, entryways, hallways, passageways, corridors, dividers, railings, portals between floors, obstacles 306, or any combination thereof, etc., just to name a few examples. A schematic map may further include one or more indications of one or more infeasible areas 308. An infeasible area 308 may comprise, by way of example but not limitation, an area to which a person does not appear to normally have access, such as an enclosed area without a door. For instance, there may be no door for infeasible area 308 because it represents space for elevator machinery. As another instance, a space on a second floor that is open to a first floor below may be indicated to be infeasible on the second floor (even if indicated to be feasible on the first floor). In contrast, a feasible area may comprise a space to which a person does have access, such as a room having a doorway.

As indicated above, indoor environment characteristics 304 may include transmitter characteristics 208. An example of transmitter characteristics 208 may include, but is not limited to, a position of one or more transmitters 104. To provide positions of one or more transmitters 104 for transmitter characteristics 208, a schematic map may also include representations of transmitters 104 or indications of positions thereof. Additionally or alternatively, one or more transmitters 104 may be linked to one or more locations on a schematic map. A schematic map for an indoor environment may be used to facilitate navigation or mobile device positioning within an indoor environment, for example. However, claimed subject matter is not limited to any particular examples of schematic map.

Indoor environment characteristics 304 may further include a graph 312. For certain example implementations, a graph 312 may comprise multiple nodes that are interconnected by edges. To create a graph 312, a grid 314 of points may be overlaid on a schematic map of an indoor area or lines interconnecting overlaid points may be drawn, for example. For the sake of visual clarity for FIG. 3, only a portion of a grid 314 or a graph 312 are explicitly shown. A connectivity graph implementation (not shown) of a graph 312 may be created, for example, by limiting lines that interconnect points to those lines that are capable of extending from one point to another point without crossing an obstacle 306, such as an impervious building feature (e.g., a wall). By way of example only, a connectivity graph may be created from graph 312 as illustrated by omitting those edges that cross a wall, door, etc. A routability graph implementation (not shown) of a graph 312 may comprise, for example, a connectivity graph that includes additional map features corresponding to indoor environment characteristics 304 so as to facilitate a determination of a route from one point (e.g., an origin or current location) to another point (e.g., a destination) of indoor area 302.

A connectivity graph or a routability graph may be linked to or otherwise associated with annotations (not separately shown). A connectivity graph, a routability graph, or annotations may be included as part of, may be linked to, or may otherwise be associated with a schematic map. Annotations may indicate point of interest (POI) features for an indoor area 302 or attributes of specific locations or aspects of a schematic map or a physical indoor environment to which it corresponds. POI features may comprise, by way of example but not limitation, names of stores; locations of restrooms; names of office inhabitants; locations of copier or break rooms; purposes of rooms; identifications of stairs, escalators, or elevators; identifications of points of ingress or egress; or any combination thereof; etc. However, claimed subject matter is not limited to any particular example implementation of a schematic map, a graph, annotations, or POI features, etc.

A connectivity graph, a routability graph, or annotations may be used to provide navigational services, such as positioning, providing static directions, providing turn-by-turn directions, or any combination thereof, etc. A navigational service may facilitate travel from a point “A” to a point “B” of e.g. an indoor environment using, for example, a routability graph. A routability graph may be descriptive of feasible areas of a given schematic map and indicate how traversal is possible from one position to another position. For a given indoor environment, a routability graph may comprise a set of nodes and edges that depict feasible areas and traversable paths from one point in an indoor environment to another point. A traversable path may comprise, by way of example but not limitation, a path along one or more edges of a routability graph that link at least two points or nodes of a routabiliy graph, with the path being unblocked by a wall 306a or other obstacle 306. By way of example but not limitation, annotations may be associated with particular portion(s) of a routability graph.

A user of a mobile device may travel within an indoor area, such as from one point to another point. For certain example implementations, as a user navigates within an indoor area, a user's mobile device may likewise move within an indoor area and thereby follow or define a path. A navigational path 210 is shown in FIG. 3 for a mobile device 102. A navigational path 210 may be comprised of one or more segments 310. A given segment 310 may be differentiated from other portions of a navigational path 210 in any one or more of multiple manners. By way of example but not limitation, a segment 310 may correspond to a place at which a positioning operation is performed, may correspond to a distance between two points (e.g., two adjacent points) in a grid 314 of points, may correspond to a regular time interval (e.g., at which positioning may occur), may correspond to where an uncertainty reduction operation 202 (e.g., of FIG. 2) is performed, may correspond to a location at which a position is determined with a predetermined confidence level, or any combination thereof, etc. A navigational path 210 or portion thereof, which may comprise at least one segment 310, of a mobile device 102 may be determined based, at least in part, on one or more positions of a mobile device, on at least one speed or direction of a mobile device (e.g., in a current or previous epoch), on a trajectory of a mobile device, on one or more mobility models, on one or more relative measurements from at least one sensor, or any combination thereof, etc., just to name a few examples.

A navigational path 210 may constrain a current location or a current estimated location of a mobile device. For example, a navigational path may indicate or limit a set of likely locations of a mobile device from a universe of possible locations within a given location context, such as within a given constrained indoor environment. As shown by way of example but not limitation, an estimated location of mobile device 102 at a terminal end of navigational path 210 may be characterized by an uncertainty 316. As described further herein, if uncertainty 316 exceeds a tolerance threshold, uncertainty 316 may be at least reduced using measured signal characteristic values of signals transmitted by one or more of transmitters 104.

Given a navigational path 210, an estimated location of a mobile device 102 may be constrained. Thus, at least one estimate of a location of a mobile device may be constrained in accordance with a navigational path of a mobile device. A constraint on an estimated location of a mobile device may be based at least partly on any one or more of a number of different factors. For example, a current terminating point of a navigational path, or estimated location of a mobile device, may be constrained based at least partially on a previous location of a mobile device, including a previous estimated location. It may be presumed that a user moves a finite distance during any given epoch in which a navigational path is being extended. Additionally or alternatively, a current terminating point of a navigational path may be constrained based at least partially on a previous velocity (e.g., on a previous speed or direction) of a mobile device, including a previous estimated velocity. It may be presumed that a user's current velocity continues for at least part of an epoch.

A navigational path may additionally or alternatively be constrained based at least partially on a routability graph. For instance, a presence or an absence of a traversable path between two points, or a shortest length of a traversable path between two points, of a routability graph may limit potential locations of a mobile device. It may be presumed that a user takes a traversable path between any two points. Also, a schematic map may be used to at least partially constrain a navigational path or an estimated location of a mobile device that is derivable from a navigational path. For instance, a schematic map may indicate feasible or infeasible locations of an indoor area. It may be inferred that a navigational path does not extend into or cross through an infeasible area. Additionally or alternatively, a navigational path may be constrained based at least partially on one or more annotations. For instance, an area that is annotated as being a relatively popular area (e.g., a break room is likely to be relatively more popular than an individual's office) may affect a navigational path.

In a navigational mode of operation for a mobile device, a user may enter a destination, such as a POI, a particular store, or any combination thereof, etc. A mobile device may use an origin or a current location in conjunction with an entered destination to determine a route to the destination. A route to a destination may be presented to a user as a visual path, as static directions, as turn-by-turn directions, or any combination thereof, etc. It may be assumed that a navigational path of a user is more likely to follow a determined route to a destination that has been presented to the user than to deviate significantly from such a route. Consequently, a destination of a user, or a route derived there from, may be used to at least partially constrain a navigational path or an estimated location of a mobile device that is derivable from a navigational path.

Additionally or alternatively, a navigational path may be constrained based at least partially on a presumed ambulatory speed. For instance, it may be presumed that a user moves at a greatest reasonable speed, an average speed, an expected speed, or some combination thereof, etc. Hence, a current terminating point of a navigational path, or estimated location of a mobile device, may be constrained based at least partially on a previous estimated location and a presumed speed of a user. A probability distribution may additionally or alternatively be used to at least partially constrain a navigational path. For instance, if one potential position is associated with a higher probability than another potential position, a current terminating point of a navigational path may be directed toward the potential position with the higher probability.

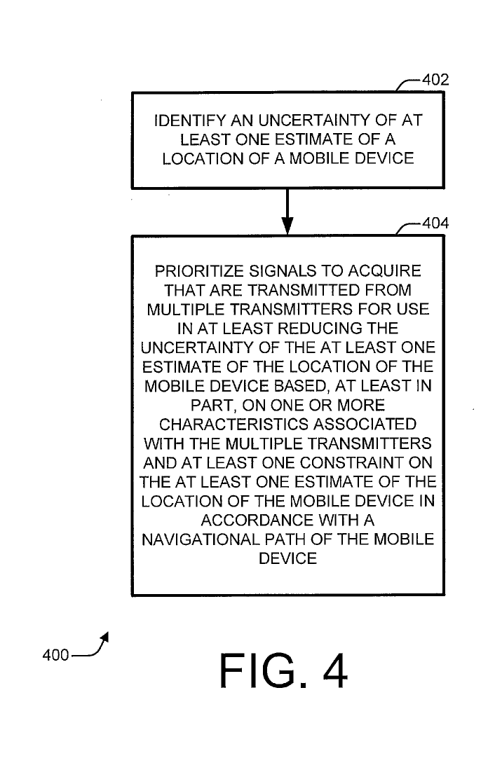

FIG. 4 is a flow diagram 400 illustrating an example method for a mobile device to facilitate positioning according to an implementation. As illustrated, flow diagram 400 may include any of operations 402-404. Although operations 402-404 are shown and described in a particular order, it should be understood that methods may be performed in alternative manners without departing from claimed subject matter, including but not limited to, with a different order or number of operations. Also, at least some operations of flow diagram 400 may be performed so as to be fully or partially overlapping with other operation(s). Additionally, although description below references particular aspects or features that may be illustrated in certain other figures (e.g., FIG. 1, 2, or 3), methods may alternatively be performed with other aspects or features.

For certain example implementations, one or more of operations 402-404 may be performed at least partially by at least one mobile device. At operation 402, an uncertainty of at least one estimate of a location of a mobile device may be identified. For example, an uncertainty (e.g., an uncertainty 110, 112, 114, 214, 316, or 704) of at least one estimated location 212 of a mobile device 102 may be identified. An uncertainty may comprise an error, a confidence range, a number of different potential locations, a distance between or among a number of different potential locations, a branching of a predicted navigational path, or any combination thereof, etc., just to name a few examples.

One or more characteristics associated with multiple transmitters may be obtained. For example, one or more transmitter characteristics 208 that are associated with multiple transmitters 104 of an indoor area 302 may be obtained. Transmitter characteristics may comprise, by way of example but not limitation, known locations, communication protocols, transmission powers, known obstacles to signal propagation, or any combination thereof, etc, of one or more transmitters.

At operation 404, signals to acquire that are transmitted from multiple transmitters for use in at least reducing the uncertainty of the at least one estimate of the location of the mobile device may be prioritized based, at least in part, on one or more characteristics associated with the multiple transmitters and at least one constraint on the at least one estimate of the location of the mobile device in accordance with a navigational path of the mobile device. For example, signals 116, which may be transmitted from multiple transmitters 104, that may be acquired for use in at least reducing uncertainty (e.g., an uncertainty 110, 112, 114, 214, 316, or 704) of at least one estimated location 212 of a mobile device 102 may be prioritized based, at least in part, on one or more transmitter characteristics 208 that are associated with multiple transmitters 104 of indoor area 302 and at least one constraint on at least one estimated location 212 of mobile device 102 in accordance with a navigational path 210 of mobile device 102. By way of example but not limitation, signals that may be acquired (e.g., to make signal reception measurements) may be prioritized (e.g., ordered) responsive to an amount by which respective signal reception measurements with respective ones of multiple transmitters 104 are expected to reduce an identified uncertainty.

Additionally or alternatively, at least one signal may be acquired to perform one or more signal reception measurements with at least one transmitter of the multiple transmitters in accordance with a prioritized order. For example, at least one signal 116 may be acquired to perform one or more signal reception measurements (e.g., direct measurements 206) with at least one transmitter 104 of multiple transmitters 104 in accordance with a prioritized order. As described herein below, fewer than all available signals, fewer than all possible signal reception measurements, or fewer than all available transmitters may be utilized to reduce an identified uncertainty.

Additionally or alternatively, an uncertainty of at least one estimate of a location of a mobile device may be reduced based, at least in part, on acquisition of one or more signals (e.g., based at least partially on one or more signal reception measurements). For example, using at least one positioning indication that is based on, or derived from, etc. one or more signal reception measurements with at least one transmitter 104, an uncertainty of at least one estimated location 212 of a mobile device 102 may be at least reduced. For instance, a positional error range may be reduced, a potential location may be eliminated, a probability may be increased, or any combination thereof, etc.

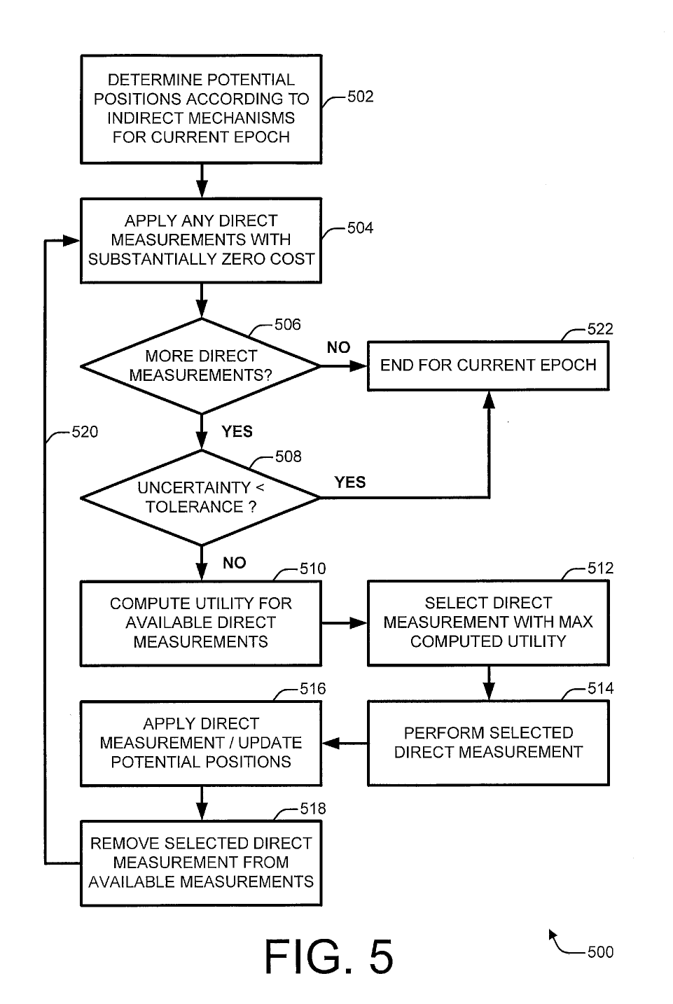

FIG. 5 is a flow diagram 500 illustrating an example method for a mobile device to facilitate positioning based at least partially on at least one computed measurement utility according to an implementation. As illustrated, flow diagram 500 may include any of operations 502-522. Although operations 502-522 are shown and described in a particular order, it should be understood that methods may be performed in alternative manners without departing from claimed subject matter, including but not limited to, with a different order or number of operations. Also, at least some operations of flow diagram 500 may be performed so as to be fully or partially overlapping with other operation(s).

For certain example implementations, one or more of operations 502-522 may be performed at least partially by at least one mobile device. At operation 502, one or more potential positions of a mobile device may be determined according to one or more indirect mechanisms for a current epoch. At operation 504, any direct measurements with substantially zero cost may be applied. For example, if a mobile device has already obtained an RSSI value for another purpose, an RSSI value may be applied to reduce an uncertainty of an estimated location without performing another direct measurement.

At operation 506, it may be determined whether there are any available direct measurements. If not, then an estimated location uncertainty cannot be reduced (or cannot be further reduced), and a positioning procedure may end for a current epoch at operation 522. If, on the other hand, more direct measurements are available, then at operation 508 it may be determined whether a current amount of uncertainty is less than an uncertainty tolerance threshold. If so, then a positioning procedure may end for a current epoch at operation 522.

If, on the other hand, a current uncertainty is greater than an uncertainty tolerance threshold (e.g., as determined at operation 508), then at operation 510 a measurement utility may be computed for available direct measurements. A measurement utility may be responsive, by way of example but not limitation, to an amount of uncertainty reduction that is expected to be achieved by a direct measurement or a cost to be incurred by a direct measurement with a transmitter. Examples of measurement utilities are described further herein below.

At operation 512, a direct measurement having a highest computed measurement utility may be selected. At operation 514, a selected direct measurement may be performed. At operation 516, at least one direct measurement may be applied to update potential positions or to reduce an uncertainty that is associated with potential positions. At operation 518, a selected direct measurement that has been performed may be removed from a listing of available direct measurements. As indicated by arrow 520, a method of flow diagram 500 may continue at operation 504. If measurement utility values are unchanged between epochs, operation 510 may be bypassed on subsequent executions, for example.

FIG. 6 is a schematic diagram 600 illustrating example uncertainties in an estimated location of a mobile device as represented by multiple particles of a particle filtering model that may be propagated along at least one hallway of a building according to an implementation. Schematic diagram 600 depicts a portion of an indoor environment that may include a hallway 108, a hallway 108a, or a hallway 108b. As illustrated, schematic diagram 600 may include at least a first transmitter 104-1 or a second transmitter 104-2, at least a first uncertainty 114a or a second uncertainty 114b, or one or more particles 602.

For certain example implementations, a path of a mobile device may be tracked or smoothed using a filtering mechanism. With reference to schematic diagram 600, a particle filtering mechanism may be implemented to estimate one or more locations of a mobile device using, for example, an approach having phases [1]-[3]. With an example implementation for particle filtering, particles may be propagated (e.g., along a nodes or edges of a routability graph) according to particle state at a phase [1]. At least one indirect positional indication of relative positional movement from one or more indirect mechanisms may be used to affect propagated particles to produce a candidate set of particles. With a phase [2], candidate particles may be assigned a probability according to one or more direct measurements. Particles may be re-sampled according to at least one probability distribution with a phase [3].

A candidate set of particles may be generated (e.g., as part of phase [1]) before any direct measurements (e.g., as part of phase [2]) are taken. Consequently, a candidate set of particles produced with a propagation phase [1] may be used to select which of one or more available direct measurements is or are to be performed. Although certain example implementations are described in terms of particle filtering, it should be understood that claimed subject matter is not so limited.

With schematic diagram 600, an example particle cloud of particles 602 may be depicted after a phase [1] has been completed but prior to performance of a phase [2]. In an example scenario, a user may have approached an intersection of hallway 108, hallway 108a, or hallway 108b. Because of uncertainty with one or more indirect mechanisms (e.g., an uncertainty in an indirect measurement due, for example, to neither a compass nor a gyroscope being present at a mobile device), particles 602 have split into two clusters. A first cluster may correspond to a first uncertainty 114a. A second cluster may correspond to a second uncertainty 114b.

For certain example implementations, indications of expected uncertainty reduction may be determined for transmitters 104. More specifically, a first indication of expected uncertainty reduction may be determined for one or more signals transmitted from first transmitter 104-1, or a second indication of expected uncertainty reduction may be determined for one or more signals transmitted from second transmitter 104-2. As shown in FIG. 6, first transmitter 104-1 is approximately equidistant from a first cluster of first uncertainty 114a and a second cluster of second uncertainty 114b. Furthermore, there are zero obstacles (i) between first transmitter 104-1 and a first cluster of first uncertainty 114a and (ii) between first transmitter 104-1 and a second cluster of a second uncertainty 114b. Consequently, a ranging value for a mobile device that is determined from a direct measurement with first transmitter 104-1 may not differentiate between first uncertainty 114a or second uncertainty 114b. In other words, a direct measurement with first transmitter 104-1 is not likely to yield a useful positioning indication in an example scenario. For example, an RSSI or an RTT for either or both clusters may be expected to be substantially equal. Applying direct measurement weights at phase [2] using one or more measurements from first transmitter 104-1 may not be likely to help distinguish between the first and second clusters. In contrast, second transmitter 104-2 is not equidistant from the first and second clusters. Applying direct measurement weights at phase [2] using one or more measurements from second transmitter 104-2 may be likely to help distinguish between the first and second clusters. Accordingly, a first indication of expected uncertainty reduction for acquiring one or more signals transmitted from first transmitter 104-1 may be determined to be lower than a second indication of expected uncertainty reduction for acquiring one or more signals transmitted from second transmitter 104-2.

For certain example implementations, a procedure as follows may be performed to selectively perform direct measurements for positioning. However, claimed subject matter is not limited to any particular procedure, aspects thereof, or stages thereof. Example variables for an example particle filtering implementation may represent the following:
P may represent a current set of particles along with their weights.
Lowercase i may represent an index of a direct measurement of multiple available direct measurements that may be performed.
Cᵢ may represent a vector of a cost associated with measurement i. For example, entries of Cᵢ may represent an energy consumption, a time that elapses, or a computational complexity, etc. corresponding to a measurement. Values for vector Cᵢ may be determined in advance or during positioning, for example.
Uppercase Iᵢ may represent an indication of an expected amount of uncertainty reduction that may be achieved by performing measurement i for particle cloud P. Examples approaches to determining indication Iᵢ are described herein below.
Uᵢ=f(Iᵢ,Cᵢ) may represent a utility of a direct measurement i. A utility function may monotonically increase with an indication I, of expected uncertainty reduction or monotonically decrease with a cost Cᵢ, for example.

An example procedure may be performed to selectively conduct direct measurements for localization with any one or more of the following ten stages:
(1) Particle propagation may be applied according to one or more indirect mechanisms.
(2) Any direct measurements with approximately zero cost may be applied.
(3) If no more direct measurements exist, then a procedure may end.
(4) If particle cloud P has a positional uncertainty<a tolerance threshold, then a procedure may end.
(5) Utility Uᵢ may be computed for potential or available direct measurements i=1, 2, 3 . . . .
(6) A measurement index, j, that maximizes Uⱼ may be selected.
(7) Direct measurement j may be conducted.
(8) Direct measurement j may be applied to update particle weights for cloud P.
(9) Direct measurement j may be removed from a list of remaining available direct measurements (e.g., if performing direct measurement j again is likely to provide little or no additional uncertainty reduction).
(10) A procedure may be continued at stage (2).

With stage (1), particle propagation may be performed according to one or more indirect mechanisms as is described herein above. One or more direct measurements may be applied in stage (2) if, for example, a mobile device already has at least one value from one or more direct measurements. For instance, if a mobile device is performing a channel scan to obtain an RSSI for an AP in a Wi-Fi implementation, a mobile device may obtain “for free” an RSSI for other APs in a same channel. With stage (4), a mobile device may analyze an uncertainty of a particle cloud. By way of example but not limitation, a metric for analyzing an uncertainty of a particle cloud may be based, at least in part, on a weighted standard deviation of a particle cloud. Additionally or alternatively, a metric for analyzing an uncertainty of a particle cloud may be based, at least in part, on a number of distinct particle clusters. If a particle cloud is associated with an uncertainty that is less than a uncertainty (e.g., distance) tolerance threshold, then performance of additional direct measurements may be obviated or omitted. Stages (6) through (10) may be performed once a utility is computed at stage (5).

With stage (5), a utility Uᵢ of a direct measurement may be computed. As noted above, a utility function may monotonically increase with an indication of expected uncertainty reduction or monotonically decrease with cost, for example. Computing a cost (e.g., in terms of energy, or latency, etc.) of a direct measurement may depend at least partly on hardware attributes of a mobile device. In an example Wi-Fi implementation, a mobile device may convert Wi-Fi measurements to one or more probability distributions using a ranging model, a heat map, or any combination thereof, etc. Consequently, a mobile device may know an expected RSSI value, or RTT value, etc. for each particle position before taking a measurement. A mobile device may use expected values to estimate an indication Iᵢ of an expected uncertainty reduction. For example, if an RTT heat map has approximately a same RTT value for each particle position of a set of particle positions, then a mobile device may infer that measuring RTT is not likely to appreciably reduce an uncertainty. Conversely, if an RSSI heat map has significantly different RSSI values across particle positions of a set of particle positions, then a mobile device may determine that an RSSI direct measurement may enable positional uncertainty to be appreciably reduced. By way of example but not limitation, an example metric for an indication of expected uncertainty reduction may comprise or be at least partly based on a standard deviation of RSSI or RTT values across particle positions of a set of estimated particle positions. However, claimed subject matter is not limited to any particular approach for determining an indication of expected uncertainty reduction.

FIG. 7 is a schematic diagram 700 of an indoor environment having multiple transmitter devices that may be prioritized for example signal reception measurements by a mobile device according to an implementation. In example implementations, signals that are transmitted by multiple transmitter devices within an indoor environment may be prioritized for acquisition, such as to measure at least one signal characteristic value. As illustrated, schematic diagram 700 depicts an example indoor area 702 that includes three transmitters 104a, 104b, or 104c, at least one mobile device 102, an uncertainty 704, or a heat map 706. Example scenarios for determining an indication of expected uncertainty reduction are described with reference to schematic diagram 700. However, claimed subject matter is not limited in any of these respects. An estimated location of a mobile device 102 is depicted in FIG. 7 along with an example uncertainty 704 that is associated with or that characterizes the estimated location. For certain example implementations, mobile device 102 may prioritize transmitters 104a, 104b, or 104c for direct measurements with signals transmitted there from to at least reduce uncertainty 704. Prioritization may be based, at least in part, on at least one indication of an expected amount of uncertainty reduction to be achieved from acquiring a signal to perform a signal reception measurement.

In an example implementation, an indication of an expected amount of uncertainty reduction may be based, at least in part, on a number of communication obstacles between mobile device 102 and a respective transmitter 104. Using a schematic map of indoor area 702 (e.g., from indoor environment characteristics 304 (e.g., of FIG. 3)) or an estimated location of mobile device 102, it may be determined, e.g.—as shown in FIG. 7, that no communication obstacles separate mobile device 102 from transmitter 104a, that one communication obstacle separates mobile device 102 from transmitter 104c, or that two communication obstacles separate mobile device 102 from transmitter 104b. Accordingly, mobile device 102 may prioritize for signal reception measurement transmitter 104a for a first direct measurement, transmitter 104c for a second direct measurement, or transmitter 104b for a third direct measurement.

In an example implementation, an indication of an expected amount of uncertainty reduction may be based, at least in part, on at least one communication protocol that transmitters 104a, 104b, or 104c are capable of using for wireless communication. Using transmitter characteristics 208 (e.g., of FIG. 2), it may be determined, for instance, that transmitter 104a uses a communication protocol that is not fully compatible with mobile device 102, that transmitter 104b uses a communication protocol that enables ranging or positioning to a first precision, or that transmitter 104c uses a communication protocol that enables ranging or positioning to a second, greater precision. Accordingly, mobile device 102 may prioritize for signal reception measurement transmitter 104c for a first direct measurement or transmitter 104b for a second direct measurement.

In an example implementation, an indication of an expected amount of uncertainty reduction may be based, at least in part, on one or more signal characteristic values from at least one heat map that includes expected signal characteristic values that are measurable from transmitters 104a, 104b, or 104c at different positions of indoor area 702. A heat map 706 may, by way of example only, comprise or indicate one or more expected signal characteristic values that correspond to one or more positions of indoor area 702. An expected measurement value may comprise a single number (e.g., 4.3), a numerical range (e.g., 4.1 to 4.5), a probabilistic range (e.g., a mean plus a standard deviation), or any combination thereof, etc., just to name a few examples. A heat map 706 may include an expected measurement value, for example, for each transmitter 104 in a given indoor area 702 (e.g., transmitter 104a, 104b, or 104c) for each feasible position of indoor area 702. Types of expected measurement values for signal characteristics may comprise, by way of example but not limitation, an RSSI, an RTT, an RTD, an AOA, a TOA, or any combination thereof; etc. A mobile device 102 may use one or more expected measurement values of a heat map 706, along with one or more measured signal characteristic values, to establish or refine a position fix.

A heat map 706 may include a map of an indoor area 702 to which it corresponds. Additionally or alternatively, a heat map 706 may reference positions that are defined or otherwise specified in a map that is included as part of, e.g., a schematic map. For the sake of visual clarity in FIG. 7, only a portion of heat map 706 is shown; a heat map 706 may actually cover less or more (e.g., an entirety) of an indoor area 702. Also, as shown in FIG. 7 merely for purposes of illustration, a heat map 706 may comprise multiple discrete points that are organized in a grid or other arrangement. Additionally or alternatively, a heat map may comprise expected measurement values that are determined based, at least partly, on a continuous positional basis or contours defined by measurement values or measurement value ranges. However, claimed subject matter is not limited to any particular implementation of a likelihood heat map.

Expected measurement values for a heat map 706 may be determined in any one or more of a number of different manners. For example, expected measurement values for signal reception with one or more transmitters 104 may be determined at least partially using one or more ranging models or a computational analysis. For instance, RSSI values for a heat map may be predicted by a ranging model to decrease with distance from a transmitter. Alternatively or additionally, expected measurement values for a heat map may be adjusted or determined based, at least in part, on actual values that are measured by mobile devices in a given indoor area when a heat map is being created or over time.

Using at least one heat map 706, it may be determined, for instance, that transmitter 104a has significantly different measurement values for positions in proximity to an estimated location of mobile device 102, that transmitter 104b has relatively faint or undetectable measurement values around an estimated location of mobile device 102, or that transmitter 104c has similar measurement values for 15 feet along a hallway in either direction from an estimated location of mobile device 102. Accordingly, mobile device 102 may prioritize for signal reception measurement transmitter 104a for a first direct measurement, transmitter 104b for a second direct measurement, or transmitter 104c for a third direct measurement. Additionally or alternatively, positions of heat map 706 that are analyzed may be selected based on a size, position, or shape of uncertainty 704. For example, those positions of heat map 706 that correspond to an example oval shape of heat map 704 (e.g., as shown in FIG. 7) may be analyzed.

In an example implementation, an indication of an expected amount of uncertainty reduction may be based, at least in part, on a shape, position, or size of an uncertainty 704. Because of a layout of a hallway as defined by obstacles (e.g. walls) that form the hallway in which mobile device 102 is located, an example uncertainty 704 may be shaped as an oval as shown in schematic diagram 700. An estimated range between mobile device 102 and transmitter 104c may form an arc that passes approximately through a longer axis of an oval shape of uncertainty 704. In contrast, an estimated range between mobile device 102 and transmitter 104a may form an arc that passes approximately through a shorter axis of an oval shape of uncertainty 704. Consequently, acquisition of a signal transmitted from transmitter 104c may be expected to reduce uncertainty 704 by a lesser amount as compared to acquisition of a signal transmitted from transmitter 104a. Accordingly, mobile device 102 may prioritize for signal reception measurement one or more signals from transmitter 104a at a higher ranking than signal reception measurement of one or more signals from transmitter 104c.

FIG. 8 is a schematic diagram illustrating an example mobile device 800, according to an implementation, that may implement one or more aspects relating to facilitating mobile device positioning. As illustrated, mobile device 800 may include at least one processor 802 (e.g., a general-purpose processor 802a or a digital signal processor 802b), one or more memories 804, at least one communication interface 806, at least one interconnect 808, at least one wireless transceiver 812, at least one SPS receiver 818, at least one AM/FM receiver 820, or one or more other component(s) 822, or any combination thereof, etc. FIG. 8 also illustrates at least one storage medium 814 or one or more networks 816. A mobile device 800 may have access to storage medium 814 or networks 816. Memory 804 or storage medium 814 may include instructions 810. However, a mobile device 800 may alternatively include or have access to more, fewer, or different components from those that are illustrated without departing from claimed subject matter.

For certain example implementations, a mobile device 102 (e.g., of FIG. 1-3 or 7) may comprise a mobile device 800. Mobile device 800 may include or comprise at least one electronic device, such as a device with processing capabilities. Mobile device 800 may comprise, for example, any electronic device having at least one processor or memory. Examples of mobile devices 800 may include, but are not limited to, a notebook or laptop computer, a personal digital assistant (PDA), a netbook, a slate or tablet computer, a portable entertainment device, a mobile phone, a smart phone, a mobile terminal (MT), a mobile station (MS), a user equipment (UE), a personal navigation device (PND), or any combination thereof, etc.

One or more processors 802 may comprise one or more separate or integrated processors. As illustrated, one or more processors 802 may comprise a general-purpose processor 802a, a digital signal processor 802b, or any combination thereof, etc. General-purpose processor 802a may be programmed with instructions, such as instructions 810, to become a special purpose processor that implements at least a portion of any process(es), method(s), or procedure(s), etc. that are described herein. A digital signal processor (DSP) 802b may comprise a processor having an architecture that is at least partially enhanced to process digital signals. Digital signal processor 802b may be programmed with instructions, such as instructions 810, to become a special purpose digital signal processor that implements at least a portion of any process(es), method(s), or procedure(s), etc. that are described herein. General-purpose processor 802a or digital signal processor 802b may operate individually or jointly to implement any e.g. procedure(s) that are described herein.

Memory 804 may store, contain, or otherwise provide access to at least a portion of instructions 810 that may be executable by a processor 802. Examples for instructions 810 may include, but are not limited to: a program, or an application, etc. or portion thereof; operational data structures; processor-executable instructions; computer-implemented instructions; code or coding; or any combination thereof; etc. Execution of instructions 810 by one or more processors 802 may transform mobile device 800 into a special purpose computing device, apparatus, platform, or any combination thereof, etc.

Instructions 810 may include, by way of example but not limitation, prioritizing instructions 810a. In certain example implementations, prioritizing instructions 810a may correspond to, for example, instructions that are capable of realizing: at least a portion of one or more implementations of flow diagrams 400 or 500 (e.g., of FIG. 4 or 5), such as any of operations 402-410 or 502-522; at least a portion of any procedures shown in or described with reference to FIGS. 1-7 from a mobile device perspective; or any combination thereof; etc., just to name a couple of examples. Other alternatives may instead be implemented without departing from claimed subject matter.

At least one communication interface 806 may provide one or more hardware or software interfaces between mobile device 800 and other devices or human operators. Hence, communication interface 806 may comprise a screen, a speaker, a microphone, a camera, a keyboard or keys, or other human-device input or output features. Additionally or alternatively, a communication interface 806 may comprise a transceiver (e.g., a transmitter or a receiver), a radio, an antenna, a network interface (e.g., a wired hardware interface connector, such as a network interface card; or a wireless interface connector, such as a Bluetooth® or near field communication (NFC) unit; etc.), a local hardware interface (e.g., a universal serial bus (USB) connector, or a Light Peak® connector, etc.), or any combination thereof; etc. to communicate wireless and/or wired signals (e.g., over wireless or wired communication links) via one or more networks 816. Communications using at least one communication interface 806 may enable transmitting, receiving, or initiating of transmissions, etc., just to name a few examples.

One or more networks 816 may comprise at least one wireless or wired network. Examples of networks 816 may include, but are not limited to, a local area network (LAN), a wireless LAN (WLAN), a wide area network (WAN), a wireless WAN (WWAN), a cellular network, a telecommunications network, the internet, an ad hoc network, an infrastructure network, or any combination thereof, etc. A storage medium 814 may comprise memory to store, for example, at least a portion of instructions 810. A storage medium 814 may be external (as shown) to mobile device 800. If external, storage medium 814 may be local or remote from mobile device 800. An external implementation of a storage medium 814 may comprise a separate memory device or may comprise part of another electronic device. Although not so explicitly illustrated, storage medium 814 may also or alternatively be located within, or be internal to, mobile device 800. Examples of storage medium 814 may include, but are not limited to, a hard drive, a disk, a disc, a storage array, a storage network, volatile memory, nonvolatile memory, a USB drive, a memory card, a computer-readable medium, or any combination thereof, etc.

Additionally or alternatively to communication interface 806, mobile device 800 may include one or more transmitters, receivers, transceivers, or any combination thereof, etc. By way of example only, a mobile device may include at least one wireless transceiver 812, at least one SPS receiver 818, at least one AM/FM receiver 820, or any combination thereof, etc. A wireless transceiver 812 may transmit or receive wireless signals in accordance with, e.g., at least one selected protocol. Example protocols may include, but are not limited to, a cellular or WWAN protocol, a Wi-Fi protocol, a Bluetooth® protocol, or any combination thereof, etc. Wireless transceiver 812 may communicate, for example, with network 816 via wireless signals. An SPS receiver 818 may at least receive SPS signals from one or more satellites, pseudolites, positioning beacons, or any combination thereof, etc. An AM/FM receiver 820 may at least receive amplitude modulated (AM) or frequency modulated (FM) signals. Although not explicitly shown in FIG. 8, wireless transceiver 812, SPS receiver 818, AM/FM receiver 820, or any combination thereof, etc. may be coupled to one or more individual antennas or shared antennas.

Mobile device 800 may include at least one interconnect 808 that comprises one or more buses, channels, switching fabrics, or combinations thereof, etc. to enable signal communication between or among components of mobile device 800. Other component(s) 822 may comprise one or more other sensors, power sources, apparatuses providing other feature(s), or any combination thereof, etc. In an example implementation, sensors may include, but are not limited to, a thermometer, a barometer, an accelerometer, a compass, a gyroscope, a pedometer, or any combination thereof, etc. Although not explicitly illustrated in FIG. 8, one or more components of mobile device 800 may be coupled to interconnect 808 via a discrete or integrated interface. By way of example only, one or more interfaces may couple wireless transceiver 812 or general-purpose processor 802a to interconnect 808.

In example implementations, a device, such as mobile device 800, may comprise at least one memory 804 and one or more processors 802. At least one memory 804 may store instructions 810. One or more processors 802 may be configured to execute instructions 810, e.g., to perform one or more procedures, processes, operations, or any combination thereof, etc. In example implementations, an article (e.g., an article of manufacture) may comprise at least one storage medium 814. At least one storage medium 814 may have stored thereon instructions 810 that are executable by one or more processors 802, e.g., to perform one or more procedures, processes, operations, or any combination thereof, etc.

Methodologies described herein may be implemented by various means depending upon applications according to particular features or examples. For example, such methodologies may be implemented in hardware, firmware, software, discrete/fixed logic circuitry, or any combination thereof, etc. In a hardware or logic circuitry implementation, for example, a processor or processing unit may be implemented within one or more application specific integrated circuits (ASICs), digital signal processors (DSPs), digital signal processing devices (DSPDs), programmable logic devices (PLDs), field programmable gate arrays (FPGAs), processors generally, controllers, micro-controllers, microprocessors, electronic devices, other devices or units programmed to execute instructions or designed to perform functions described herein, or combinations thereof, just to name a few examples. Herein, the term “control logic” may encompass logic implemented by software, hardware, firmware, discrete/fixed logic circuitry, or any combination thereof, etc.

For a firmware or software implementation, methodologies may be implemented with modules (e.g., procedures, functions, etc.) having instructions that perform functions as described herein. Any machine readable medium tangibly embodying instructions may be used in implementing methodologies as described herein. For example, software coding may be stored in a memory or executed by a processor. Memory may be implemented within a processor or external to a processor. As used herein the term “memory” may refer to any type of long term, short term, volatile, nonvolatile, or other storage memory/medium and is not to be limited to any particular type of memory or number of memories, or type of media upon which memory is stored.

In one or more example implementations, functions described herein may be implemented in hardware, software, firmware, discrete/fixed logic circuitry, any combination thereof, etc. If implemented in firmware or software, functions may be stored on a physical computer-readable (e.g., via electrical digital signals) medium as one or more instructions or code (e.g., realized as at least one article of manufacture comprising at least one storage medium having instructions stored thereon). Computer-readable media may include physical computer storage media that may be encoded with a data structure, a computer program, or any combination thereof, etc. A storage medium may be any available physical medium that can be accessed by a computer. By way of example, and not limitation, such computer-readable media may comprise RAM, ROM, EEPROM, CD-ROM or other optical disc storage, magnetic disk storage or other magnetic storage devices, or any other medium that can be used to store desired program code in the form of instructions or data structures and that can be accessed by a computer or processor thereof. Disk and disc, as used herein, may include compact disc (CD), laser disc, optical disc, digital versatile disc (DVD), floppy disk and blu-ray disc, where disks usually reproduce data magnetically, and discs usually reproduce data optically with lasers.

Also, computer instructions, code, or data, etc. may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, or microwave. Combinations of the above may also be included within the scope of physical transmission media. Such computer instructions or data may be transmitted in portions (e.g., first and second portions) at different times (e.g., at first and second times).

Network or networks may operate in accordance with any one or more of many different systems, standards, or protocols, etc., just to name a few examples. For example, for an implementation including at least one wireless communication network, such wireless communication network(s) may comprise one or more of a wireless wide area network (WWAN), a wireless local area network (WLAN), a wireless personal area network (WPAN), any combination thereof, and so on. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination thereof, and so on. A CDMA network may implement one or more radio access technologies (RATs) such as cdma2000, Wideband-CDMA (W-CDMA), Time Division Synchronous Code Division Multiple Access (TD-SCDMA), or any combination thereof, etc., just to name a few radio technology examples. Here, cdma2000 may include technologies implemented according to IS-95 standards, IS-2000 standards, IS-856 standards, or any combination thereof, etc. A TDMA network may implement Global System for Mobile Communications (GSM), Digital Advanced Mobile Phone System (D-AMPS), or some other RAT or RATs. GSM and W-CDMA examples are described in documents from a consortium named “3rd Generation Partnership Project” (3GPP). Cdma2000 examples are described in documents from a consortium named “3rd Generation Partnership Project 2” (3GPP2). 3GPP and 3GPP2 documents are publicly available. A WLAN may include an IEEE 802.11x network, and a WPAN may include a Bluetooth network or an IEEE 802.15x network, just to name a few examples. Wireless communication networks may include so-called next generation technologies (e.g., “4G”), such as, for example, Long Term Evolution (LTE), Advanced LTE, WiMAX, Ultra Mobile Broadband (UMB), or any combination thereof, or the like.

Some portions of this Detailed Description are presented in terms of algorithms or symbolic representations of operations on binary digital signals that may be stored within a memory of a specific apparatus or special purpose computing device or platform. In the context of this particular Specification, the term specific apparatus or the like includes a general purpose computer once it is programmed to perform particular functions pursuant to instructions from program software or instructions. Algorithmic descriptions or symbolic representations are examples of techniques used by those of ordinary skill in the signal processing or related arts to convey the substance of their work to others skilled in the art. An algorithm here, and generally, may be considered to be a self-consistent sequence of operations or similar signal processing leading to a desired result. In this context, operations or processing may involve physical manipulation of physical quantities. Typically, although not necessarily, such quantities may take the form of electrical or magnetic signals capable of being stored, transferred, combined, compared, transmitted, received, or otherwise manipulated.

It has proven convenient at times, principally for reasons of common usage, to refer to such signals as bits, data, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “obtaining,” “transmitting,” “receiving,” “acquiring”, “performing,” “applying,” “predicting”, “positioning/locating,” “storing,” “providing,” “making”, “identifying”, “demodulating”, “prioritizing”, “reducing”, “selecting”, “removing” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Likewise, the terms, “and” and “or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic, etc. in the singular or may be used to describe some combination of features, structures, or characteristics, etc. However, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concepts described herein. Therefore, it is intended that claimed subject matter not be limited to the particular examples disclosed, but that such claimed subject matter may also include all aspects falling within the scope of appended claims, and equivalents thereof.

What is claimed is:

1. A method for a mobile device, the method comprising:
identifying an uncertainty of at least one estimate of a location of the mobile device; and
prioritizing signals to acquire that are transmitted from multiple transmitters for use in at least reducing the uncertainty of the at least one estimate of the location of the mobile device based, at least in part, on one or more characteristics associated with the multiple transmitters and at least one constraint on the at least one estimate of the location of the mobile device in accordance with a navigational path of the mobile device.

2. The method of claim 1, wherein said prioritizing of the signals to acquire comprises:
determining the at least one constraint on the at least one estimate of the location of the mobile device based, at least in part, on at least one routability graph that indicates one or more traversable paths.

3. The method of claim 1, wherein said prioritizing of the signals to acquire comprises:
determining the at least one constraint on the at least one estimate of the location of the mobile device based, at least in part, on at least one schematic map that indicates one or more infeasible areas.

4. The method of claim 1, wherein said prioritizing of the signals to acquire comprises:
determining the at least one constraint on the at least one estimate of the location of the mobile device based, at least in part, on at least one destination entered by a user.

5. The method of claim 4, wherein said determining of the at least one constraint comprises:
determining the at least one constraint on the at least one estimate of the location of the mobile device based, at least in part, on at least one route to the at least one destination that is entered by the user.

6. The method of claim 1, wherein said prioritizing of the signals to acquire comprises:
determining the at least one constraint on the at least one estimate of the location of the mobile device based, at least in part, on at least one ambulatory speed of a user that is carrying the mobile device.

7. The method of claim 1, wherein said identifying of the uncertainty of the at least one estimate of the location of the mobile device comprises:
determining the navigational path of the mobile device based, at least in part, on a constrained indoor environment.

8. The method of claim 1, wherein said identifying of the uncertainty of the at least one estimate of the location of the mobile device comprises:
determining the navigational path of the mobile device using at least one indirect mechanism.

9. The method of claim 8, wherein said determining of the navigational path of the mobile device comprises:
extending the navigational path of the mobile device using at least one mobility model and based, at least in part, on at least one previous estimate of the location of the mobile device or at least one previous estimate of a speed or a direction of travel of the mobile device.

10. The method of claim 8, wherein said determining of the navigational path of the mobile device comprises:
extending the navigational path of the mobile device using at least one sensor of the mobile device and based, at least in part, on at least one sensor measurement characterizing movement of the mobile device to travel to the at least one estimate of the location of the mobile device.

11. The method of claim 1, wherein said prioritizing of the signals to acquire comprises:
determining indications of expected uncertainty reduction for the signals that are transmitted from the multiple transmitters.

12. The method of claim 1, further comprising:
responsive to said prioritizing of the signals to acquire, acquiring one or more signals from a selected transmitter of the multiple transmitters and obtaining at least one characteristic of the one or more signals from the selected transmitter; and
reducing the uncertainty of the at least one estimate of the location of the mobile device based, at least in part, on the at least one characteristic of the one or more signals.

13. The method of claim 1, wherein said prioritizing of the signals to acquire comprises:
prioritizing acquisition of the signals from at least two transmitters of the multiple transmitters based, at least in part, on predicted measurement utilities corresponding to the signals that are transmitted from the multiple transmitters.

14. The method of claim 13, wherein said prioritizing acquisition of the signals comprises:
determining the predicted measurement utilities corresponding to the signals that are transmitted from the multiple transmitters based, at least in part, on an expected amount of uncertainty reduction to be achieved and a cost to be incurred by acquiring the signals that are transmitted from the multiple transmitters.

15. The method of claim 1, wherein the one or more characteristics associated with the multiple transmitters comprise at least known locations of the multiple transmitters; and wherein said prioritizing of the signals to acquire comprises:
analyzing the at least one estimate of the location of the mobile device in relation to the known locations of the multiple transmitters.

16. The method of claim 15, wherein said one or more characteristics associated with the multiple transmitters further comprises at least one of signal transmission power, signal bandwidth or expected signal-to-noise.

17. The method of claim 15, wherein the one or more characteristics associated with the multiple transmitters further comprise at least communication obstacles of a constrained indoor environment in which the mobile device is currently located; and wherein said prioritizing of the signals to acquire further comprises:
analyzing the communication obstacles that are potentially located between the at least one estimate of the location of the mobile device and the known locations of the multiple transmitters in the constrained indoor environment.

18. The method of claim 1, wherein said prioritizing of the signals to acquire comprises:
analyzing the at least one estimate of the location of the mobile device in relation to signal characteristic values that are expected to be measurable with respect to individual ones of the multiple transmitters using one or more heat maps.

19. The method of claim 1, wherein the at least one estimate of the location of the mobile device comprises at least a first estimated location and a second estimated location of the mobile device, and the first estimated location and the second estimated location are jointly associated with the uncertainty of the at least one estimate of the location of the mobile device, and wherein the uncertainty comprises a measure of positional ambiguity; and wherein said prioritizing of the signals to acquire comprises:
determining from the multiple transmitters a selected transmitter that is transmitting a selected signal that is at least more likely to reduce the measure of positional ambiguity responsive to a prediction that acquiring the selected signal from the selected transmitter is expected to provide a first signal characteristic value if the mobile device is positioned at the first estimated location and a second signal characteristic value if the mobile device is positioned at the second estimated location, with the first signal characteristic value differing from the second signal characteristic value.

20. A mobile device comprising:
a receiver; and
a processor to:
identify an uncertainty of at least one estimate of a location of the mobile device; and
prioritize acquisition of signals received at the receiver and transmitted from multiple transmitters for use in at least reducing the uncertainty of the at least one estimate of the location of the mobile device based, at least in part, on one or more characteristics associated with the multiple transmitters and at least one constraint on the at least one estimate of the location of the mobile device in accordance with a navigational path of the mobile device.

21. The mobile device of claim 20, wherein said processor to prioritize acquisition of the signals by:
determining the at least one constraint on the at least one estimate of the location of the mobile device based, at least in part, on at least one routability graph that indicates one or more traversable paths.

22. The mobile device of claim 20, wherein said processor to prioritize acquisition of the signals by:
determining the at least one constraint on the at least one estimate of the location of the mobile device based, at least in part, on at least one ambulatory speed of a user that is carrying the mobile device.

23. The mobile device of claim 20, and further comprising one or more sensors, and wherein said processor is further to:
determine the navigational path using at least one indirect mechanism by extending the navigational path of the mobile device based, at least in part, on at least one sensor measurement characterizing movement of the mobile device to travel to the at least one estimate of the location of the mobile device.

24. The mobile device of claim 20, wherein said processor is further to:
responsive to said prioritization of acquisition the signals, initiate acquisition by said receiver of one or more signals from a selected transmitter of the multiple transmitters and obtaining at least one characteristic of the one or more signals from the selected transmitter; and
reduce the uncertainty of the at least one estimate of the location of the mobile device based, at least in part, on the at least one characteristic of the one or more signals.

25. An article comprising:
a storage medium comprising machine-readable instructions stored thereon which are executable by a special purpose computing apparatus to:
identify an uncertainty of at least one estimate of a location of a mobile device; and
prioritize acquisition of signals received at a receiver and transmitted from multiple transmitters for use in at least reducing the uncertainty of the at least one estimate of the location of the mobile device based, at least in part, on one or more characteristics associated with the multiple transmitters and at least one constraint on the at least one estimate of the location of the mobile device in accordance with a navigational path of the mobile device.

26. The article of claim 25, wherein acquisition of said signals received at the receiver is to be prioritized at least in part by:
determining the at least one constraint on the at least one estimate of the location of the mobile device based, at least in part, on at least one schematic map that indicates one or more infeasible areas.

27. The article of claim 25, wherein said uncertainty of the at least one estimate of the location of the mobile device is to be determined at least in part by:
determining the navigational path of the mobile device based, at least in part, on a constrained indoor environment.

28. An apparatus comprising:
means for identifying an uncertainty of at least one estimate of a location of the mobile device; and
means for prioritizing signals to acquire that are transmitted from multiple transmitters for use in at least reducing the uncertainty of the at least one estimate of the location of the mobile device based, at least in part, on one or more characteristics associated with the multiple transmitters and at least one constraint on the at least one estimate of the location of the mobile device in accordance with a navigational path of the mobile device.
